(19) United States
(12) Patent Application Publication
(10) Pub. No.: US 2003/0009842 A1
(43) Pub. Date: Jan. 16, 2003

(54) Wiper blade for cleaning glass surfaces on motor vehicles

(76) Inventor: Bruno Egner-Walter, Heilbronn (DE)

Correspondence Address: Andrew R Basile, Young & Basile, Suite 624, 3001 West Big Beaver Road, Troy, MI, 48084, US

(21) Appl. No.: 10/203,998

(22) PCT Filed: Feb. 20, 2001
(86) PCT No.: PCT/EP01/01910

(30) Foreign Application Priority Data
Feb. 21, 2000 (DE) 100 07 810.9

(51) Int. Cl. B60S 1/38

(52) U.S. Cl. 15/250.43; 15/250.361

(57) ABSTRACT

The invention relates to a wiper blade (1) for cleaning glass surfaces on vehicles, especially motor vehicles. The inventive wiper blade consists of an elongated wiper strip (2) consisting of an elastic rubber material and at least one spring bar (3) that is connected to the wiper strip and is curved in such a way that the wiper strip is provided with a different curvature on both sides (1′, 1″) of a connecting element (9) for connecting to a wiper blade arm.

The invention relates to a wiper in accordance with the preamble in claim 1.

Wiper blades for cleaning glass surfaces on automobiles are known in a wide variety of embodiments and basically consist of a wiper body made of a flexible rubber material extending in the longitudinal direction of the wiper blade and of at least one supporting strip or spline. It is particularly known (e.g. DE 198 02 451) to shape or to curve one spline made from spring steel strip in such a way that the wiper blade as a whole has a curvature in the longitudinal direction, specifically a concave curvature on the underside of the wiper blade with which it presses against the glass surface to be cleaned, and on the upper side a convex curvature. However, in known wiper blades this curvature is symmetrical to the center of the wiper blade. blade also press against the glass surface to be cleaned. However, it has been shown that with different glass surface shapes satisfactory wiping results cannot be achieved with this known configuration.

It is further known (DE 121 47 161) to design splines curved symmetrically to the center such that their cross-section decreases with increasing distance from the center of the spline.

The object of the present invention is to demonstrate a wiper blade which allows improved wiping performance with the lowest possible production cost. To achieve this object a wiper blade is configured in accordance with claim 1.

On both sides of the connecting element or adapter respectively, with which the wiper blade can be attached to the arm of a windshield wiper, the wiper blade of the invention has a different curvature at least over part of its length, where the distance of the two ends of the wiper blade from a cross-sectional plane at the connecting element, or connecting area, is the same in a first embodiment, and is different in a second possible embodiment. The distance of the wiper blade end from the said cross-sectional plane, for example in the case of the wiper blade section which has the greater curvature, i.e. the smaller curvature radius, is then shorter than in the case of the other wiper blade section.

Further improvement to the invention are the subject of the subclaims. The invention is explained in more detail in what follows with reference to the drawings.

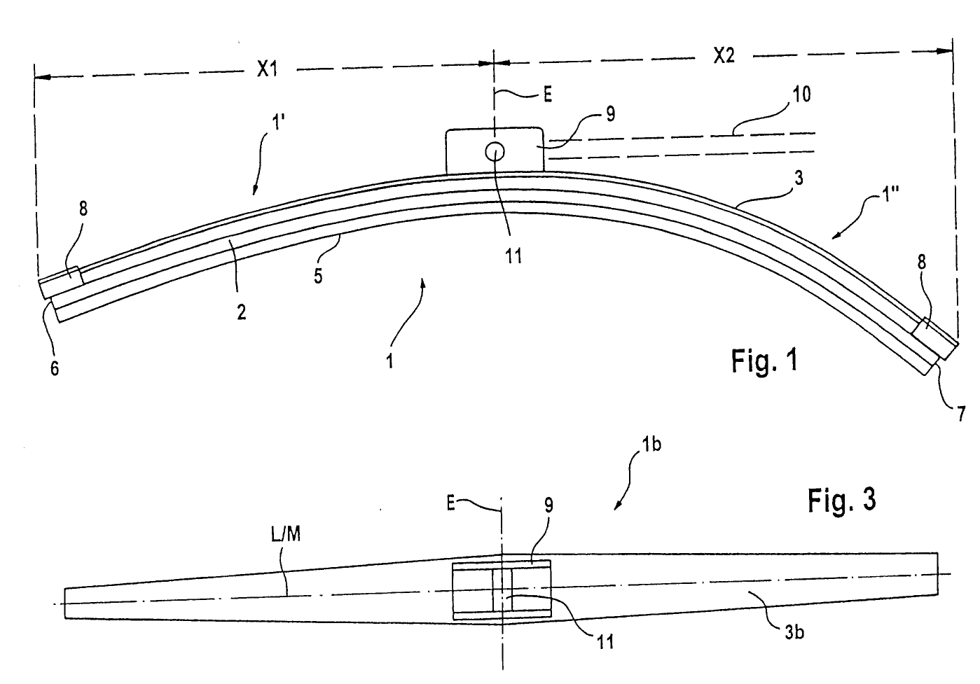

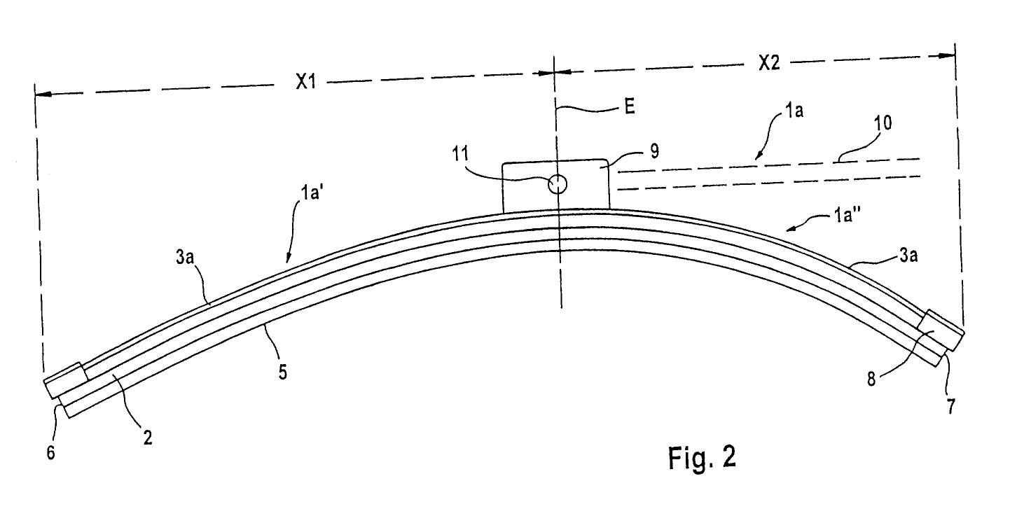

FIGS. 1 and 2 show two possible embodiments of the wiper blade of the invention in a simplified representation and in a side view;

FIG. 3 shows in a simplified representation a top view of a further possible embodiment of the wiper blade of the invention.

The wiper blade identified in FIG. 1 with 1 consists in a known way of an elongate wiper body 2 which is made from a flexible rubber material, for example by injection molding, pressing or as profiled material, and of the support strip or spline 3, which is manufactured from a flexible flat material, preferably from spring steel or spring steel strip, and which like the wiper body 2 extends over the entire length of the wiper blade 1. In the case of the embodiment shown, the spline 3 is provided on the upper side of the flat wiper body 2 and is attached to it in a suitable fashion, for example by bonding. The wiper body 2 forms a wiper lip 5 on its underside in a known way with which it presses against the glass surface to be cleaned during operation of the wiper blade 1.

In the embodiment shown end caps 8 are attached at both ends 6 and 7 of the wiper blade 1, which connect the two splines to each other there and advantageously cover at least the sharp corners of the wiper body 2. Between the two ends 6 and 7, on the upper side of the wiper blade 1 facing away from the wiper lip 5, provision is made for a bracket or adapter 9 as a connecting element which is connected to the spline 3 in a suitable fashion, for example by spot welding and via which the wiper blade 1 is connected to the end of a purely schematically represented wiper arm 10 of a windshield wiper. In the cases of the embodiment shown, the adapter 9 is furnished for this purpose with a connecting pin 11, which lies with its axis perpendicular to a center plane M (FIG. 3) located parallel to the drawing plane in FIG. 1, in which center plane the longitudinal extension L of the wiper blade 1 is also located and to which, for example, the wiper blade 1 and the wiper body 2 are disposed symmetrically in cross-section.

As FIG. 1 shows, the wiper blade 1 is curved on the upper side, i.e. in the area of the spline 3, as well as on the underside, i.e. in the area of the wiper lip 5, specifically convexly on the upper side and concavely on the underside. In FIG. 1, E indicates a cross-sectional plane running perpendicular to the plane of the drawing, in which the axis of the connecting pin 11 also lies and which runs perpendicular to the tangent of the curvature of the wiper blade 1 in the area of the adapter 9.

X1 and X2 in FIG. 1 identify the distances of end 6 or 7 from the plane E respectively. In the case of wiper blade 1 these distances X1 and X2 are equal. But as FIG. 1 shows, the curvature of the wiper blade 1, shown in a relaxed state in this figure, is less pronounced in one wiper blade section 1′ between end 6 and plane E, i.e. the radius of the curvature is greater there than in the other section of the wiper blade 1″ between plane E and end 7. Wiper blade section 1″ therefore has a more pronounced curvature or a smaller radius of curvature, respectively, at least in a partial area, than wiper blade section 1′. As can be further seen from FIG. 1, wiper blade section 1″ actually has a somewhat greater length than wiper blade section 1′ on account of this more pronounced curvature in spite of the equal distance X1 and X2 from plane E. As a result of the different curvature in wiper blade sections 1′ and 1″, these sections and especially ends 6 and 7 press flexibly against the glass surface in spite of its normal curvature, so that optimal cleaning or wiping results are achieved.

FIG. 2 shows in a representation like FIG. 1 as a further possible embodiment a wiper blade la which includes the wiper body 2 and the spline 3a and differs specifically from wiper blade 1 in that the distances X1 and X2 of the ends 6 and 7 respectively from the plane E of the adapter 9 are different, so that the adapter is positioned off-center.

FIG. 3 shows as a further possible embodiment a wiper blade lb in a plan view of the top side. Also shown in FIG. 3 is the previously mentioned center plane M as well as plane E of the adapter 9. Both planes lie perpendicular to each other and perpendicular to the plane of the drawing in FIG. 3.

The width of spline 3b decreases in the longitudinal direction L of the wiper blade with increasing distance from plane E, from a maximum width in the area of the adapter 9 to a narrower width at each of the ends 6 and 7. In the embodiment shown, the width of spline 3b is smaller at end 6 than at end 7. The spline 3b is symmetrical to the center plane M. Furthermore, both ends are the same distance from plane E, so that to this extent the wiper blade lb is the same as wiper blade 1.

The invention was described in what preceded using embodiments. It is clear that numerous changes and adaptations are possible without departing from the inventive idea underlying the invention.

For example, it is possible to connect the respective splines 3, 3a or 3b in another suitable way to the respective wiper body 2, for example by forming the wiper strip as one with the spline. It is furthermore possible to furnish two splines in place of one spline 3, 3a or 3b, each of which engages a lateral longitudinal groove in wiper body 2.

List of Reference Numerals

| | |
|---|---|
| 1, 1a, 1b | Wiper blade |
| 1′, 1″ | Wiper blade section |
| 2 | Wiper body |
| 3, 3a, 3b | Spline |
| 5 | Wiper lip |
| 6, 7 | End |
| 8 | End cap |
| 9 | Adapter |
| 10 | Wiper arm |
| 11 | Connecting pin |
| X1, X2 | Distance |
| L | Longitudinal extent |
| M | Center plane |
| E | Plane of the adapter |

What is claimed is:

1. Wiper blade for cleaning glass surfaces on vehicles, specifically motor vehicles, having an elongate wiper body (2) consisting of a flexible rubber material, which can be pressed against the particular glass surface in the area of its underside or with at least one wiper lip (5) formed there and is furnished with at least one spline (3, 3a, 3b) extending in the longitudinal direction of the wiper strip (2), where the support strip in a relaxed state of the wiper blade is curved in such a way that the wiper blade is curved concavely on its underside in the longitudinal direction and convexly on an upper side facing away from the underside, and also having a connecting element (9) furnished between two ends (6, 7) of the wiper blade (1, 1a, 1b) to attach the wiper blade to an arm of a windshield wiper, characterized in that the curvature of the wiper blade (1, 1a, 1b) or the shape of this curvature in a first wiper blade section (1′) formed between one end (6) of the wiper blade (1, 1a, 1b) and the connecting element (9) is different from the curvature of the wiper blade (1, 1a, 1b), or from the shape of this curvature in a second wiper blade section (1″) formed between the connecting element (9) and the other end (7).

2. Wiper blade from claim 1, wherein the first wiper blade section (1′) at least over a partial length has a curvature with a radius that is greater than the radius of the curvature of at least a partial length of the second wiper blade section (1″).

3. Wiper blade from claim 1 or 2, wherein the first wiper blade section (1′) and/or the second wiper blade section (1″) have a curvature in which the curvature or the curvature radius, respectively, change in the longitudinal direction of the wiper blade.

4. Wiper blade from one of the preceding claims, wherein the distance (X1, X2) of the two ends (6, 7) of the wiper blade (1, 1b) is the same from a cross-sectional plane (E) of the wiper blade (1) in the area of the connecting element (9).

5. Wiper blade from one of the preceding claims, wherein the distance (X1, X2) of both ends (6, 7) of the wiper blade (1, 1b) from a cross-sectional plane (E) of the wiper blade (1) is different in the area of the connecting element (9).

6. Wiper blade from claim 5, wherein the other end (7) forming the second section (1″) of the wiper blade has the shorter distance from the cross-sectional plane (E).

7. Wiper blade from one of the preceding claims, wherein at least the one spline (3b) has a changing cross-section in the longitudinal direction (L) of the wiper blade (1b) or a changing width in the longitudinal direction of the wiper blade (1b).

8. Wiper blade from claim 7, wherein the cross-section or the width of at least the spline (3b) decreases from the connecting element (9) toward at least one end (6, 7) of the wiper blade (1b).

9. Wiper blade from claim 8, wherein the cross-section or the width decreases at both ends (6, 7).

10. Wiper blade from one of the preceding claims, wherein at least one spline (3, 3a, 3b) has a different cross-section or a different width at the ends (6, 7) of the wiper blade (1b).
